(19) United States
(12) Patent Application Publication
(10) Pub. No.: US 2004/0168543 A1
(43) Pub. Date: Sep. 2, 2004

(54) Driving unit for a motor vehicle

(75) Inventor: Ulrich Huelsemann, Neuhausen (DE)

Correspondence Address: CROWELL & MORING LLP, INTELLECTUAL PROPERTY GROUP, P.O. BOX 14300, WASHINGTON, DC, 20044-4300, US

(73) Assignee: Dr. Ing. h.c.F. Porsche AG, Stuttgart (DE)

(21) Appl. No.: 10/774,408

(22) Filed: Feb. 10, 2004

(30) Foreign Application Priority Data
Feb. 28, 2003 (DE) 103 08 757.5

(51) Int. Cl. F16H 57/02

(52) U.S. Cl. 74/606 R

(57) ABSTRACT

A driving unit is appropriate for a motor vehicle, especially a passenger automobile of the sport car type, a driving unit which comprises an internal combustion engine and a housing component, preferably to accommodate a clutch, a transmission and a differential. In order to optimize the driving unit, the housing component, which receives the clutch and is joined to the internal combustion engine, has first bearings and second bearings for an input shaft as well as an output shaft of the transmission and third bearings for the differential, while a container area for containing a dry sump lubrication of the internal combustion engine is integrated into the housing component.

### BACKGROUND AND SUMMARY OF THE INVENTION

This application claims the priority of German Patent Document No. 103 08 757.5, filed Feb. 28, 2003, the disclosure of which is expressly incorporated by reference herein.

The invention relates to a driving unit for a motor vehicle, especially a passenger automobile of the sport car type.

EP 0 183 051 A1 discloses a drive unit of the kind referred to above in the rear end of the passenger automobile, as shown in FIG. 13, and it is formed by an internal combustion engine and a transmission which are interlocked with one another. Different housings are provided for a differential and a transmission.

U.S. Pat. No. 4,920,825 discloses an internal combustion engine for a motor vehicle, which comprises a housing structure into which a cylinder block, a crankcase and a transmission case are integrated. A starting device is affixed to the housing structure and cooperates with a starting gear on an intermediate shaft. The intermediate shaft cooperates with a crankshaft of the internal combustion engine.

One of the objects of the invention is to create a driving unit for a passenger automobile in which an internal combustion engine, a clutch, a transmission and a differential are arranged in a desirable spatial relationship with one another. The clutch, transmission and differential are to be combined in an advantageously configured housing component.

This object is achieved according to the invention by the invention described and claimed hereinafter.

Certain advantages of the invention are that the housing component contains the clutch and, due to the provision of the first, second and third bearings, contains the input shaft as well as the output shaft of the transmission plus the differential in an eminently practical manner. The range of the application of the housing component is further expanded by the integration of the space containing the dry sump lubrication of the internal combustion engine. Manufacture of the housing component is simplified if it is manufactured independently of the housing structure of the internal combustion engine, the housing structure and the housing component being combined in a compact unit on a common plane of separation. The spatial arrangement is benefited, mainly on the length of the vehicle, by the fact that the input shaft and the output shaft of the transmission are at right angles to the length of the crankshaft. Furthermore, the housing component is configured to contain the clutch and a starter for the internal combustion engine, so that as a result of the specific design measures it will be able to serve additional functions.

Other objects, advantages and novel features of the present invention will become apparent from the following detailed description of the invention when considered in conjunction with the accompanying drawings.

### BRIEF DESCRIPTION OF THE DRAWINGS

FIG. 1 is a top view of a driving unit according to the invention, installed in a partially represented passenger automobile,

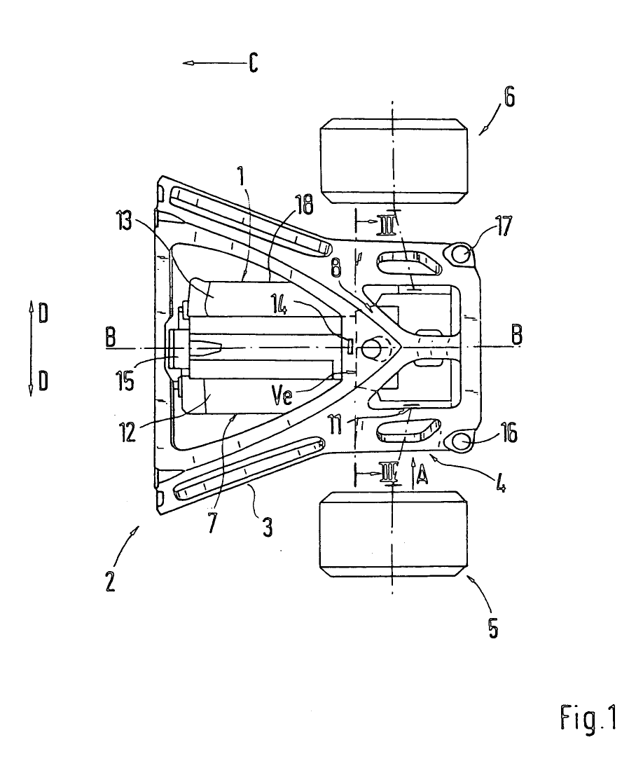

FIG. 2 is an oblique view of the driving unit seen from the right rear of the passenger automobile,

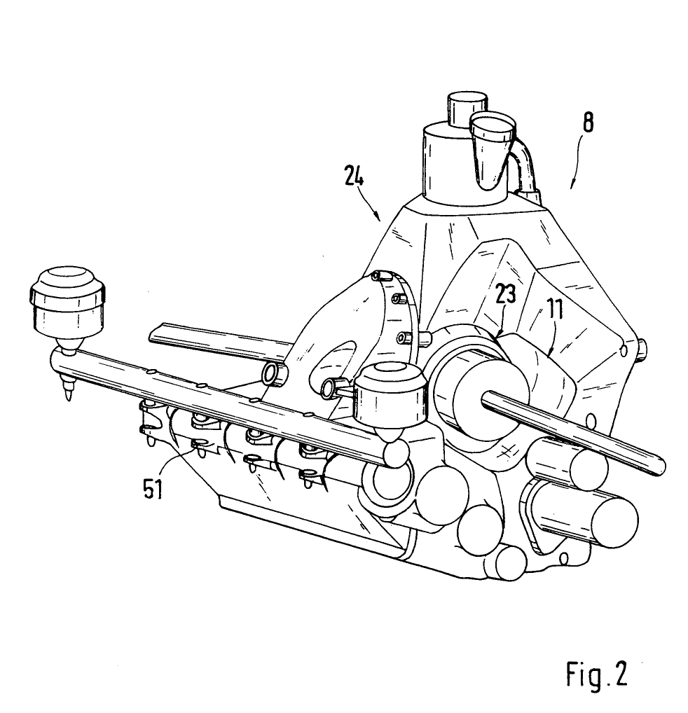

FIG. 3 is a section taken along line IV-IV of FIG. 1 on a larger scale,

FIG. 4 is a view in the direction of arrow A of FIG. 1, on a larger scale,

FIG. 5 is an oblique view from the left rear of a housing component of the driving unit,

FIG. 6 is an oblique view of the housing component, partially cut away, from the left front,

FIG. 7 is a section approximately on line VII-VII of FIG. 1,

FIG. 8 is a view corresponding to FIG. 7, and

FIG. 9 is an oblique, left rear view of the back of the internal combustion engine.

### DETAILED DESCRIPTION OF THE DRAWINGS

A driving unit 1 is installed in a passenger automobile 2 of the sport car type—a dynamic, attention-getting automobile—of which only a mounting 3 of the driving unit 1 and a rear axle 4 with wheels 5 and 6 are shown. The driving unit 1 comprises an internal combustion engine 7 and a housing component 8 which is designed to contain a clutch 9 of a transmission 10 and a differential 11. The internal combustion engine 7, represented schematically, has opposing rows of cylinders 12, 13 and a crankshaft 14 and runs approximately in a longitudinal central plane B-B of the passenger automobile 2. The engine 7 is situated in front of the rear axle 4 as seen in the direction of travel C—a mid-engine system—and it is directly united with the housing component 8. Furthermore, the driving unit 1 is affixed through the medium of a front unit bearing 15 and rear unit bearings 16, 17 to the mounting 3, which is configured in the manner of a cowling completely surrounding said driving unit 1a.

The housing component 8 is produced as a unit separately from a housing structure 18 of the internal combustion engine 7, and both are combined at a junction plane Ve which is aligned in the direction D-D across the vehicle. The housing component 8 accommodates the clutch 9 joined to the crankshaft 14 of the internal combustion engine 7, and it has a first bearing 19 and second bearing 20 for an input shaft 21 and an output shaft 22 of the driving unit 10, which shafts are aligned with the longitudinal central plane B-B of the passenger automobile 1. Moreover, the housing component 8 is provided with three bearings 23 for the differential 11. And a container area 24 for dry sump lubrication is integrated into the housing component 8.

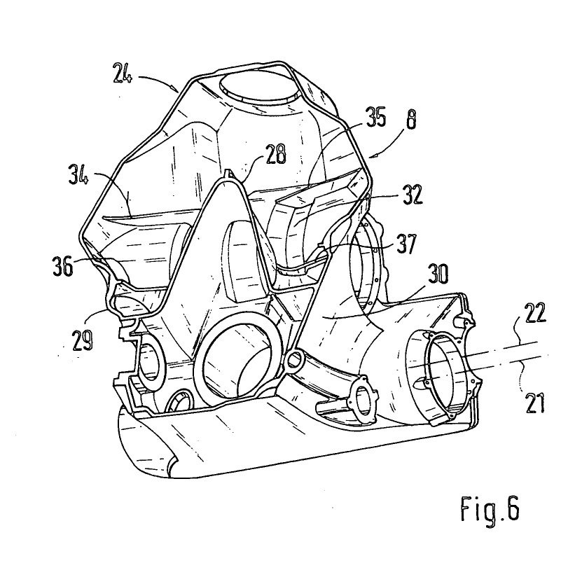

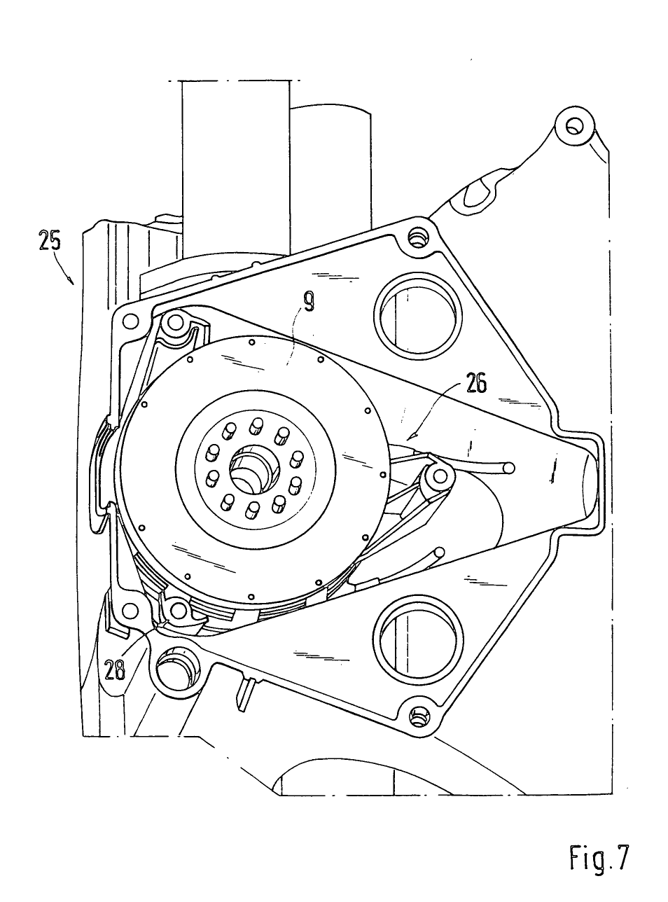

On one side 25 facing the internal combustion engine 7, the housing component 8, made from, for example, a light metal alloy, is provided with a chamber 26 which contains in a substantially complete manner the clutch 9 together with a bracket 27 for a disengaging device 28 (FIG. 7). The chamber 26 is of trapezoidal shape, tapering to the container area 24 lying above the clutch 9. For that purpose a roof-shaped housing wall 28 is embodied in the container area 24 (FIG. 6), which joins together the opposite side walls 29 and 30 and forms two spaces 31 and 32 of relatively great volume for the container area 24 of the dry sump lubrication. Between the back wall 33 and the side walls 29 and 30 are reinforcing ribs 34-35 and 36-37 extending approximately horizontally and offset vertically.

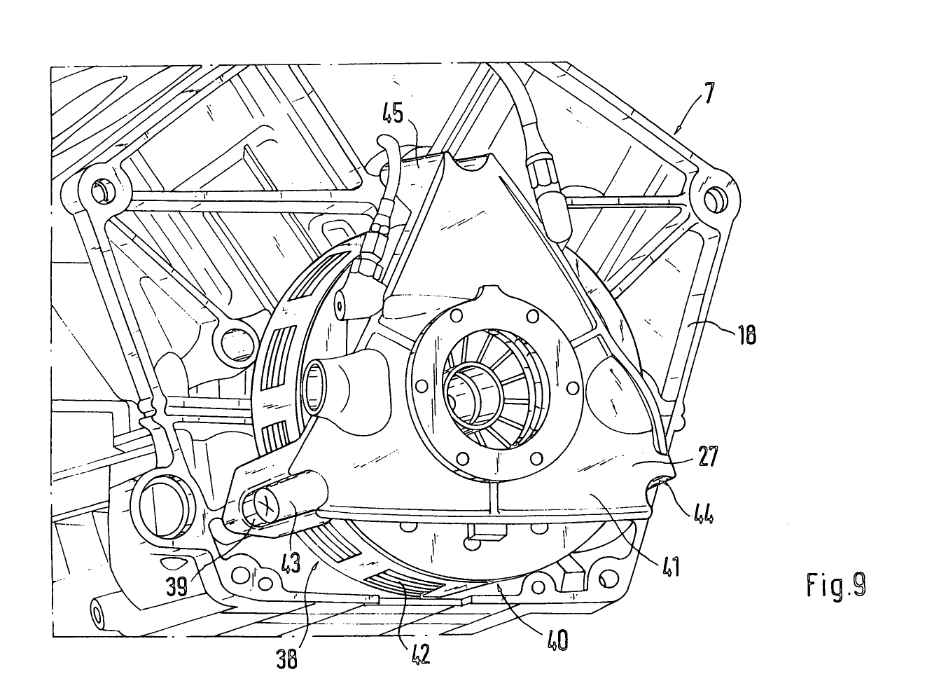

The clutch 9 is joined by a flywheel 38 to the crankshaft 14 of the internal combustion engine 7, which is not shown. On the other hand the bracket 27 is fastened by screws 39 to the housing structure 18 of the internal combustion engine 7, namely on a side 40 facing the housing component 8. For this purpose the bracket 27 comprises a base plate 41 in the shape of an equilateral triangle. At the apexes of the triangle three mounting studs 43, 44 and 45 are provided which are supported on the housing structure 18 of the internal combustion engine 7 (FIG. 9).

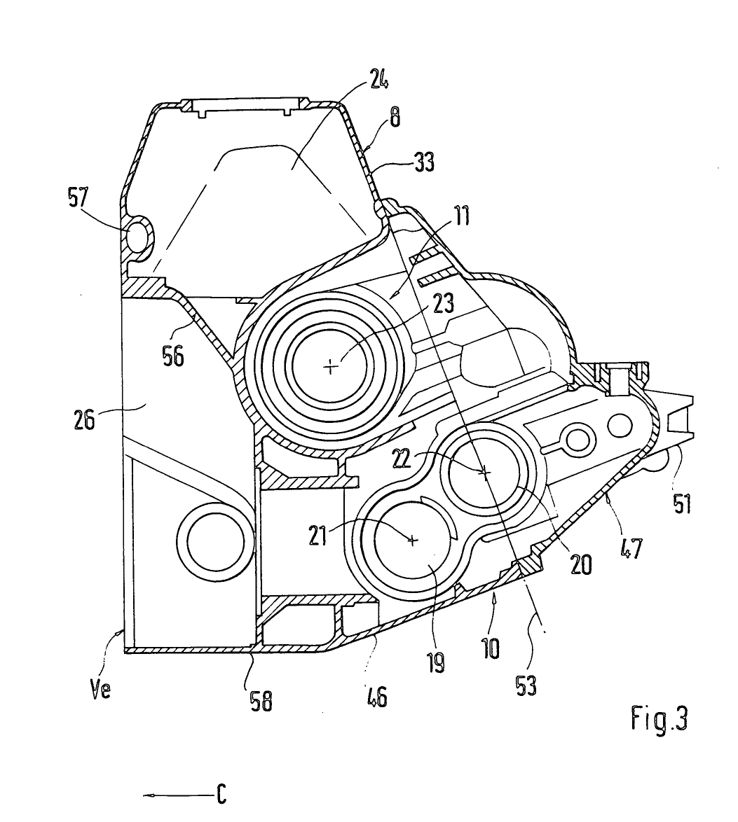

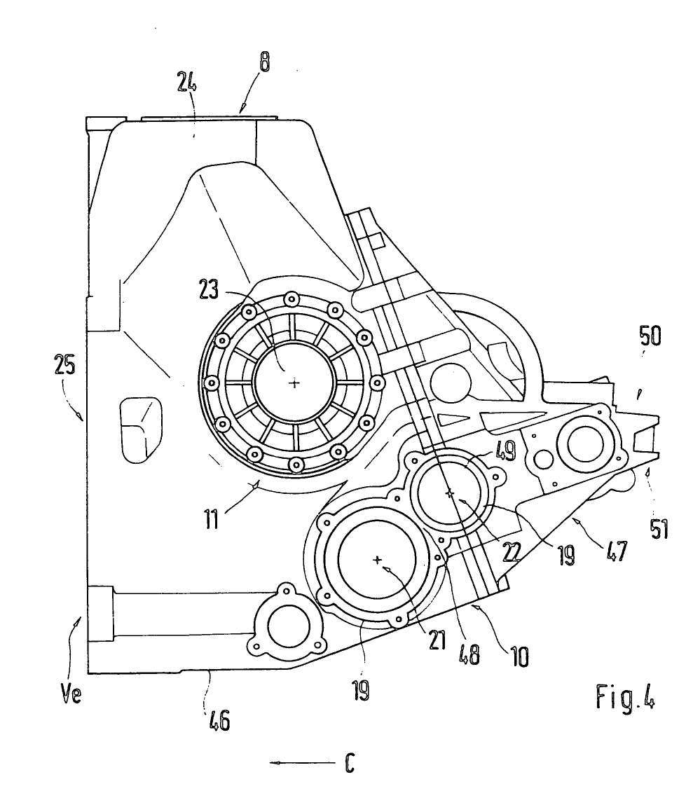

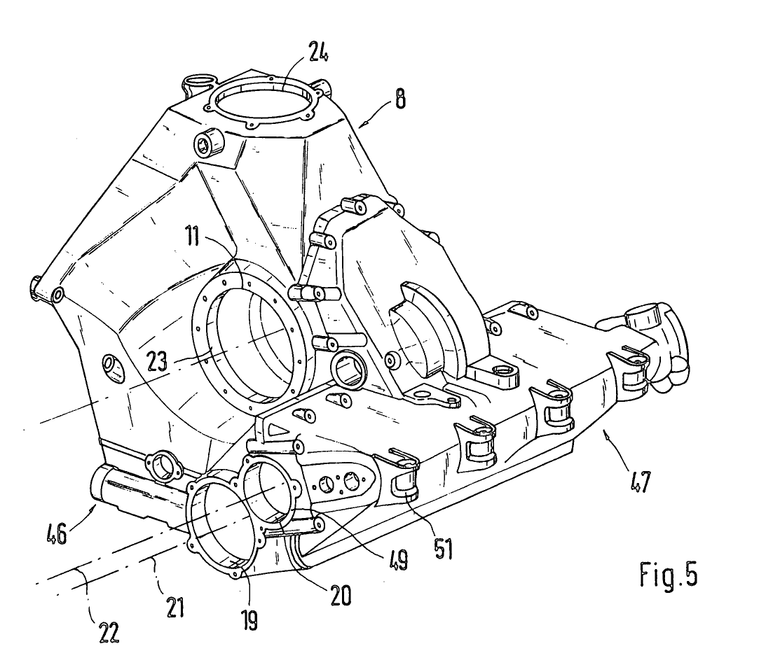

According to FIGS. 3 to 5, the housing component 8 comprises a first housing part 46 and a second housing part 47. In the first housing part 46 the first bearings 19 are provided for the input shaft 21 and the third bearings 23 for the differential 11. The second housing part 47 and the first housing part 46 form the bearings 20 for the output shaft 22, such that the bearings 20 are represented by bearing halves 48 and 49 of the first housing part 46 and second housing part 47. This housing part 47 is provided on one side 50 facing away from the internal combustion engine 7 with at least one supporting bracket 51 for mounting the crossbeam 52 extending between the unit supports 16 and 17. The support halves 47 and 49 lie on either side of a plane of separation 53 running relatively vertically, along which the first housing part 46 and the second housing part 47 are joined together through the medium of bolts 54. In FIG. 3 it can be seen that the container 24, the receiving chamber 26 and the differential chamber 55 are separated from one another by a wall structure 56. This wall structure 56 connects the back wall 33 to the front wall 57 and a bottom 58, so that a rigid frame structure for the housing component 8 is formed.

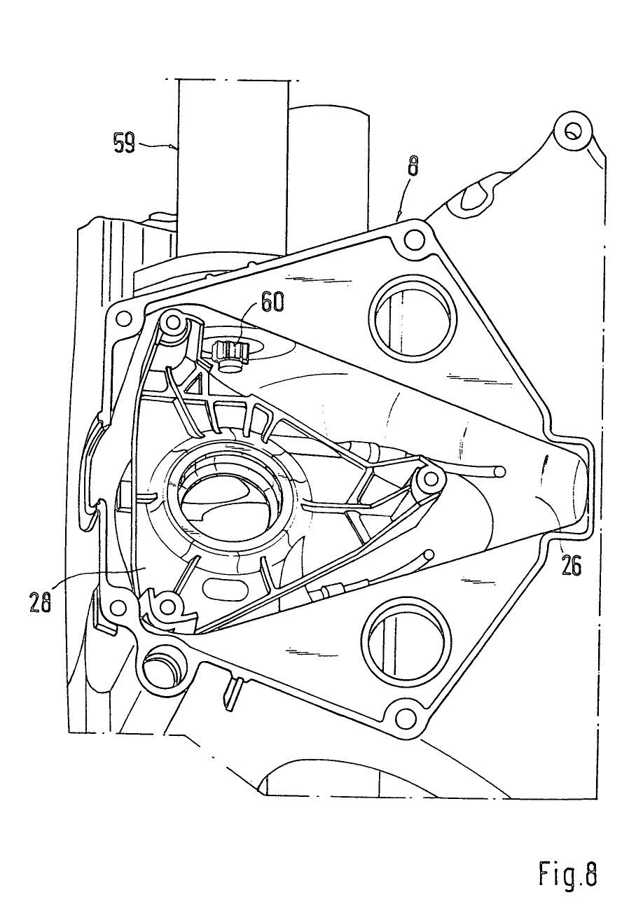

FIG. 8 shows how a starter 59 for the internal combustion engine 1 is inserted into the housing component 8. Then the starter 59 with a starter gear 60 passes through the side wall 29 of the housing component 8, the starter gear 60 cooperating with sprocket element of the clutch 9.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Driving unit for a motor vehicle, especially for a passenger automobile of the sport car type, which comprises an internal combustion engine and a housing component preferably for receiving a clutch, a transmission and a differential, wherein the housing component of the driving unit that receives the clutch and is joined to the internal combustion engine has a first bearing and a second bearing for an input shaft as well as an output shaft of the transmission and a third bearing for the differential, a container area for a dry sump lubrication of the internal combustion engine is integrated into the housing component.

2. Driving unit according to claim 1, wherein the housing component and a housing structure of the internal combustion engine are assembled together as separate components on a junction plane.

3. Driving unit according to claim 1, wherein the input shaft and output shaft are disposed transversely across a longitudinal central plane of the passenger automobile.

4. Driving unit according to claim 1, wherein the housing component has a chamber on the side facing the internal combustion engine for the clutch.

5. Driving unit according to claim 4, wherein the clutch is held in position through the medium of a flywheel on a crankshaft of the internal combustion engine.

6. Driving unit according to claim 1, wherein the housing component comprises a first housing part for the first bearing of the input shaft and the third bearing 23 of the differential, a second housing part forming together with the first housing part the second bearing for the output shaft.

7. Driving unit according to claim 6, wherein the second bearings are formed by bearing halves of the first housing part and of the second housing part.

8. Driving unit according to claim 7, wherein the bearing halves are provided on both sides of a plane of separation at which the first housing part and the second housing part are assembled.

9. Driving unit according to claim 1, wherein the plane of separation between the first housing part and the second housing part is relatively upright.

10. Driving unit according to claim 1, wherein the housing component is configured to receive a starter of the internal combustion engine, which cooperates with the clutch.

11. Driving unit according to claim 10, wherein the starter with the starter gear is brought through a side wall of the housing assembly, the starter gear cooperating with a sprocket of the clutch.

12. Driving unit according to claim 1, wherein the housing component is provided on a side facing away from the internal combustion engine with at least one support bracket for the mounting of a driving unit.

13. A driving unit for a motor vehicle, comprising:
an internal combustion engine;
a housing component for receiving at least one of a clutch, a transmission and a differential, wherein the housing component is joined to the internal combustion engine, the housing component including,
a first bearing,
a second bearing for an input shaft and an output shaft of the transmission,
a third bearing for the differential, and
a container area for a dry sump lubrication of the internal combustion engine.

14. The driving unit according to claim 13, wherein the housing component and a housing structure of the internal combustion engine are assembled together as separate components on a junction plane.

15. The driving unit according to claim 13, wherein the input shaft and output shaft are disposed transversely across a longitudinal central plane of the passenger automobile.

16. The driving unit according to claim 13, wherein the housing component includes a chamber for the clutch on a side facing the internal combustion engine.

17. The driving unit according to claim 16, wherein the clutch is held in position through a medium of a flywheel on a crankshaft of the internal combustion engine.

18. The driving unit according to claim 13, wherein the housing component includes a first housing part for the first bearing for the input shaft and the third bearing 23 for the differential, and a second housing part forming together with the first housing part for the second bearing for the output shaft.

19. The driving unit according to claim 18, wherein the second bearings includes bearing halves of the first housing part and of the second housing part.

20. The driving unit according to claim 19, wherein the bearing halves are provided on both sides of a plane of separation at which the first housing part and the second housing part are assembled.

21. The driving unit according to claim 20, wherein the plane of separation between the first housing part and the second housing part is relatively upright.

22. The driving unit according to claim 13, wherein the housing component is configured to receive a starter of the internal combustion engine, which cooperates with the clutch.

23. The driving unit according to claim 22, wherein the starter having a starter gear is brought through a side wall of the housing assembly, the starter gear cooperating with a sprocket of the clutch.

24. The driving unit according to claim 13, wherein the housing component has, on a side facing away from the internal combustion engine, at least one support bracket for the mounting of a driving unit.

25. A method for making a driving unit for a motor vehicle, comprising the steps of:
providing a housing component for receiving at least one of a clutch, a transmission and a differential;
joining the housing component to an internal combustion engine of the vehicle; and
providing the housing component with
a first bearing,
a second bearing for an input shaft and an output shaft of the transmission,
a third bearing for the differential, and
a container area for a dry sump lubrication of the internal combustion engine.
